(19) United States
(12) Patent Application Publication
(10) Pub. No.: US 2005/0275752 A1
(43) Pub. Date: Dec. 15, 2005

(54) System and method for transmitting scalable coded video over an ip network

(75) Inventors: Qiong Li, Tappan, NY (US); Mihaela Van Der Schaar, Martinez (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/531,617

(22) PCT Filed: Sep. 19, 2003
(86) PCT No.: PCT/IB03/04254

§ 371 Date: Apr. 14, 2005

Related U.S. Application Data
(60) Provisional application No. 60/418,635, filed on Oct. 15, 2002.
(60) Provisional application No. 60/451,916, filed on Mar. 4, 2003.

(51) Int. Cl. H04N 7/16; H04N 11/04; H04N 11/02; H04N 7/12; H04N 9/74

(52) U.S. Cl. 348/398.1; 725/135; 348/586; 725/139

(57) ABSTRACT

A system and method is provided to facilitate the transmission of scalable coded video over IP networks. A proposed pre-processing method is disclosed, referred to as multi-track hinting, efficiently structures layered video into a flexible format so that it can be easily streamed over packet-switching networks in accordance with changing network conditions, complexity constraints and user preferences. A general purpose MPEG server, without major modification, is capable of automatically using multiple channels (i.e., RTP connections), thereby providing the streaming system the flexibility to adapt to changing network conditions, complexity constraints and user preferences by adjusting the number of scalable layers to be transmitted. Accordingly, the multi-track hinting method extends the functions of standard Internet streaming protocols (RTSP, SDP) to enable flexible adaptation.

The present invention is directed, in general, to video encoding methods and, more specifically, to a method for streaming scalable coded video over an IP network.

With the rapid development of broadband technologies, video streaming is envisioned to become the dominant Internet application in the near future. Real-time streaming of multimedia content over data networks, including the Internet, has become an increasingly common application in recent years. A wide-range of interactive and non-interactive multimedia applications, such as news-on-demand, live network television viewing, video conferencing, among others, rely on end-to-end streaming video techniques. In support of this development, the falling cost of WLAN products and the higher bandwidth provided by new WLAN technologies such as IEEE 802.11a and 802.11g will ultimately lead to their increasing use for video transmission. Consequently, future wireless video applications will have to work over an open, layered, Internet-style network with a wired backbone and wireless extensions. Therefore, common protocols will have to be used for the transmission across both the wired and wireless portions of the network. These protocols will most likely be future extensions of the existing protocols that are based on the Internet Protocol (IP)

Due to the inherent resource sharing nature of the Internet and wireless networks, multimedia communications of the future will mainly use variable bandwidth channels. Hence, if streaming of video content is performed over networks employing variable bandwidth channels, the instantaneous data rate must frequently be tailored to fit the available resources. This can be achieved through scalable video coding. Scalable video-coding schemes are able to provide a simple and flexible framework for transmission over a heterogeneous network for a number of reasons including (1) enabling a streaming server to perform minimal real-time processing and rate control when outputting a very large number of simultaneous unicast (on-demand) streams; (2) being highly adaptable to unpredictable bandwidth variations due to heterogeneous access-technologies of the receivers (e.g., analog modems, cable modems, XDSL, etc.) and due to dynamic changes in network conditions (e.g., congestion events); (3) enabling processors with low computational power to decode only a subset of the scalable video stream; (4) support both multicast and unicast applications; and (5) being resilient to packet and bit error losses.

Examples of scalable coding schemes include, for example, MPEG-4 Fine Granularity Scalability (FGS), Advanced FGS, Data-Partitioning, MPEG-4 Spatial and Temporal Scalabilities and the emerging Motion-Compensated Wavelet Solutions.

The MPEG-4 Systems Group has developed a standard media file format (.mp4) that contains timed media information for multimedia presentation either locally or remotely (such as streaming). This format is deliberately designed with high flexibility and extensibility in order to facilitate interchange, management, editing, and presentation of the media.

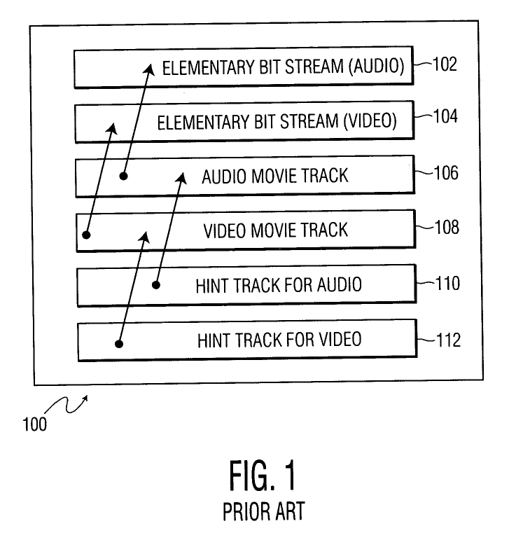

FIG. 1 illustrates, at the highest level of abstraction, the structure of an MPEG-4 movie file (i.e., .mp4 file) 100 which can be viewed as a structure containing elementary bit streams generated by encoders (i.e., elementary bit stream (audio) 102, elementary bit stream (video) 104), movie tracks to guide a player for local playback and contain data such as timing and data pointers that a player will use to extract the right media data for presentation at the proper time (i.e., audio movie track 106, video movie track 108), hint tracks for streaming the media over packet-based network and contain information such as timing, data pointers and data for packet headers that a server will use to generate packets from the elementary bit streams (i.e., hint track for audio 110, hint track for video 112).

The arrows show a relationship that exists between the various streams described above. Specifically, the video movie track 108 is related to the video elementary bit stream 104; the audio movie track 106 is related to the audio elementary bit stream 102; the hint track for video 112 is related to the video movie track 108; and the hint track for audio 110 is related to the audio movie track 106.

When an .mp4 file format is used in a streaming application, normally the server will establish as many (Real-time Transport Protocol) RTP connections as there are hint tracks contained in the file. In other words, there is a one-to-one relationship between RTP connections and hint tracks. Each RTP connection will be assigned with a hint track and responsible for delivering packets generated from that track. RTP is an Internet protocol for transmitting real-time data such as audio and video. RTP itself does not guarantee real-time delivery of data, but it does provide mechanisms for the sending and receiving applications to support streaming data. Typically, RTP runs on top of the UDP protocol, although the specification is general enough to support other transport protocols. The User Datagram Protocol is a connectionless protocol that, like TCP, runs on top of IP networks. Unlike TCP/IP, UDP/IP provides very few error recovery services, offering instead a direct way to send and receive datagrams over an IP network.

One drawback of the *mp4 file format described above is that it does not explicitly address the requirement of layered video streaming. As is well known, in layered video coding, compressed video is structured into multiple sub-layers. These layers can be progressively added to improve video quality. Layered video coding typically generates one elementary bit-stream that can be divided into sub-layers having different priorities. A limitation of applying the generic mp4 file format to the multiple layered video streams is that only one RTP connection is available to stream the layered video. This is undesirable in that scalable coding based on this inflexible streaming strategy does not allow for the desired adaptation to channel characteristics, complexity, etc.

There is therefore a need in the art for an architectural framework for streaming scalable coded video over IP networks that allow a server to create multiple RTP connections to accommodate each sub-layer of a layered video stream which allows for the desired adaptation to channel characteristics, complexity, etc.

The present invention addresses the foregoing need by providing an architectural framework for streaming scalable coded video over IP networks. The novel architecture uses multiple IP connections for both unicast and multicast to deliver scalable coded video.

Thus, according to one aspect, the present invention is a system (i.e., a pre-processing hinting method, an apparatus, and computer-executable process steps) for flexible scalable video packetization. The proposed pre-processing method, referred to herein as multi-track hinting, is advantageously backward compatible with the current MPEG-4 media file format standard, thereby making it possible to use a general purpose MPEG-4 streaming server to efficiently stream layered video in accordance with changing channel characteristics, complexity constraints and user preferences. That is, the server, without major modification, is capable of automatically using multiple channels (i.e., RTP connections), thereby providing the streaming system the flexibility to adapt to network conditions by adjusting the number of scalable layers to be transmitted. Accordingly, the multi-track hinting method extends the functions of standard Internet streaming protocols (RTSP, SDP) to enable flexible adaptation.

Advantageously, the hinting method of the invention overcomes a limitation of the prior art in that the mp4 file format did not explicitly address the requirement of layered video streaming. As such, only a single RTP connection was available to stream the layered video over an IP network. A single RTP connection is undesirable for a number of reasons including an inability to adapt to changing channel characteristics, complexity constraints and user preferences.

Referring now to the drawings where like reference numbers represent corresponding parts throughout:

FIG. 1 illustrates the structure of an MPEG-4 movie file in accordance with the prior art;

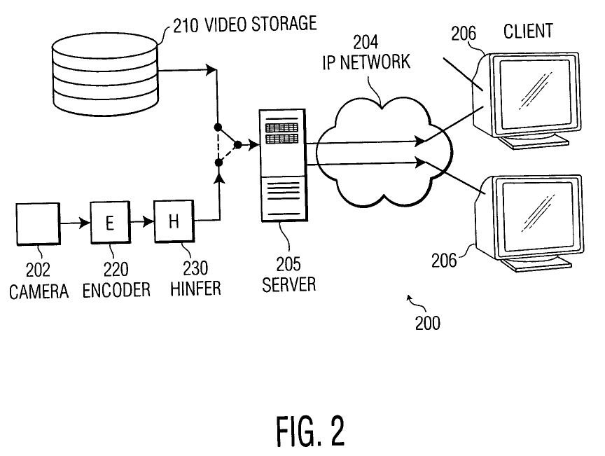

FIG. 2 illustrates a video distribution system in which the method of the invention may be implemented;

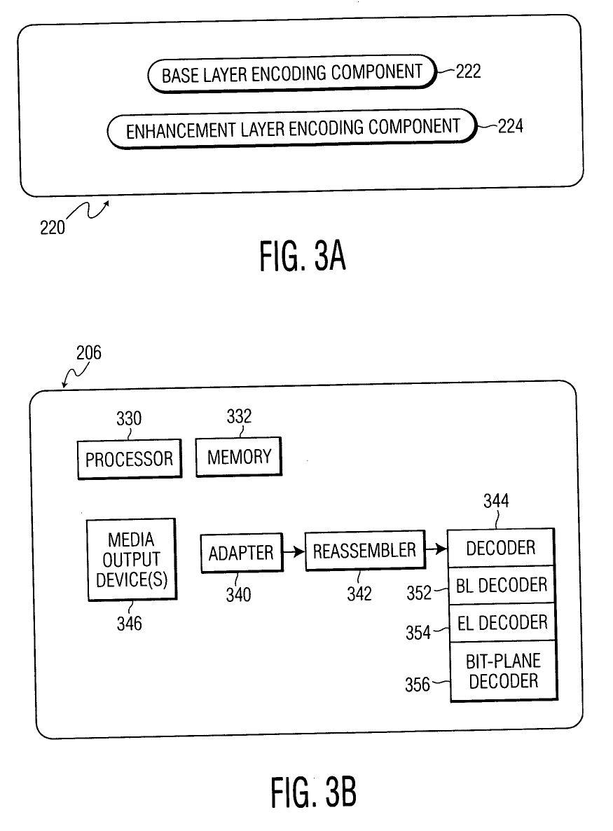

FIG. 3a is a more detailed illustration of the video encoder 220 of FIG. 2;

FIG. 3b is a more detailed illustration of the client of FIG. 2; and

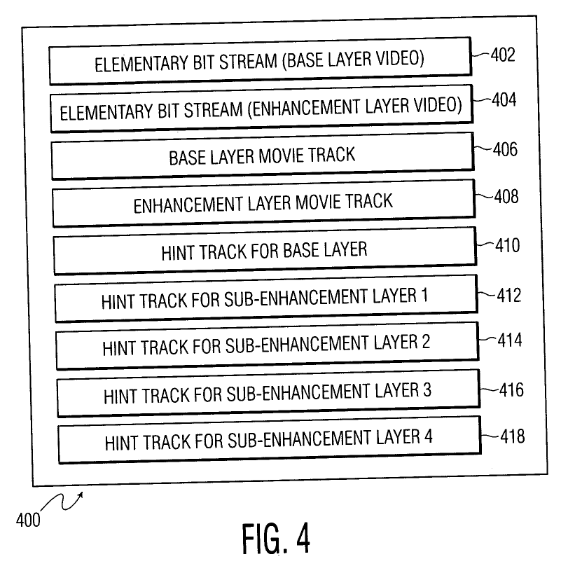

FIG. 4 conceptually illustrates a layered coding scheme to construct a scalable coded bit-stream for transmission over an IP network in accordance with one embodiment of the invention.

The accompanying printed appendix, is incorporated in and constitutes a part of this specification, illustrates an embodiment of the invention and, together with the description, serves to explain the principles of the invention. The appendix is written in a pseudo-code.

Appendix 1 contains a description of an algorithm for FGS multi-track hinting. The function max_channel_allocation(i) will determine the bit rate that will be allocated to the ith RTP connection associated with the ith hint track. Therefore, the algorithm pre-determines the bit rates of the streaming channels at the hinting stage. It is further noted that it is also possible to develop algorithms for packetization and rate-allocation optimizations when specific network conditions and codec characteristics are taken into account. However, these algorithms are application specific, and will not be further discussed in this disclosure.

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

Generally, the techniques described below can be integrated into a variety of scalable coding schemes to improve enhancement layer robustness. The coding scheme is described in the context of delivering scalable bit-stream over a network, such as the Internet or a wireless network. However, the layered video coding scheme has general applicability to a wide variety of environments. Furthermore, the techniques are described in the context of the MPEG-4 coding scheme, although the techniques are also applicable to other motion-compensation-based multiple layer video coding technologies.

The MPEG-4 Systems Group has developed and standardized a streaming strategy for “non-scalable” coded video over IP networks. The Inventor has recognized, however, that a novel streaming architecture is required for the transmission of “scalable” video formats that can efficiently adapt to changing channel conditions, complexity constraints and user preferences. The Inventor has further recognized that the scalable video streaming system architecture should be compatible with the non-scalable streaming system architecture defined by the MPEG-4 Systems Group, to allow a general purpose MPEG-4 streaming server to deliver both scalable and non-scalable video formats.

To this end, the invention relates to resolving the problem that arises in the .mp4 file format, defined by the MPEG-4 Systems Group, in that the .mp4 file format does not explicitly address the requirement of layered video streaming. Specifically, at present there is no mechanism for creating multiple RTP connections to take advantage of the scalability provided with layered coding. As such, the present invention provides an architectural framework for streaming scalable coded video over IP networks that allow a server to create multiple RTP connections to accommodate each sub-layer of a layered video stream which allows for the desired adaptation to channel characteristics, complexity, client preference, etc.

Although a detailed description of the MPEG-4 standard will not be provided herein, an overview of certain aspects of the standard will be presented to aid in understanding the present invention.

The MP4 file format, initially based on QuickTime, is designed to contain the media information of an MPEG-4 presentation in a flexible, extensible format that facilitates interchange, management, editing, and presentation of the media. The media-data in MP4 is encapsulated in frames with description headers. The meta-data is used to describe the media data characteristics (media type, times stamps, size . . . ) by reference, not by inclusion. The specifications of MPEG-4 Systems use “.mp4” as the format-identifying extension which has a specific way to handle streaming for non-scalable coded video over IP networks: the encoded content is stored in the .mp4 file format as media tracks (for example, audio is a media track, video is another media track, etc). (See FIG. 1) Additionally, the transport mechanism can be stored in the file by adding specific hint tracks, one per media track: with such a mechanism, a single file can be used as a single container for the media data themselves, in the media tracks, and for transport specific data, in the hint tracks. The MPEG-4 file format is defined normatively: the data entities stored in the media tracks are MPEG-4 Access Units, which are generally larger than a network packet. The role of the hint track will then be to store the information about how the network packets are made, how they can be filled: the hint track indeed contains pre-segmentation information so that a server knows how to fragment each Access Unit into network packets. Therefore one can first generate media tracks and store them in a .mp4 file, and then use a separate hinter program in order to parse this file, analyze the Access Unit structure, and generate suitable additional hint tracks.

FIG. 2 shows a video distribution system 200 in which a video source 202 (e.g., a camera) produces video content to be encoded by an encoder 220 from which one or more hint tracks are generated by a hinter 230 for distribution over an IP network 204, via a general purpose MPEG-4 streaming server 205, to a client 206. The network 204 is representative of many different types of networks, including the Internet, a LAN (local area network), a WAN (wide area network), a SAN (storage area network), and wireless networks (e.g., satellite, cellular, RF, etc.). While the illustrative example describes the distribution of video content over the network 204, the invention has wider applicability to the distribution of multimedia content which may include video, audio, graphical, textual, and the like. FIG. 2 also shows a video storage unit 210 to store digital video files which may be produced by the video source 202 for example.

The video encoder 220 may be implemented in software, firmware, and/or hardware. The encoder 220 is shown as a separate standalone module for discussion purposes, but may be constructed as part of a processor (not shown) or incorporated into an operating system (not shown) or other applications (not shown).

FIG. 3a is a more detailed illustration of the video encoder 220 of FIG. 2. As shown, the video encoder 220 is equipped with a base layer encoding component 222 and an enhancement layer encoding component 224. The video encoder 220 encodes the video data into multiple layers, including a base layer and an enhancement layer. The base layer encoding component 222 encodes the video data in the base layer. The base layer encoding component 222 produces a base layer elementary bit-stream (base layer video) 402 (See FIG. 4) that may be protected by conventional error protection techniques, such as FEC (Forward Error Correction) techniques.

The video encoder 220 enhancement layer encoding component 224 encodes the enhancement layer. The enhancement layer encoder 224 creates a single elementary bit stream (enhancement layer video) 404 (See FIG. 4) that is sent over the network 204 either wholly or partially, via the general purpose MPEG-4 streaming server 205 to the client 206 independently of the base layer bit-stream. The enhancement layer encoder inserts unique resynchronization marks and header extension codes into the enhancement bit-stream that facilitate syntactic and semantic error detection and protection of the enhancement bit-stream.

FIG. 3b is a more detailed illustration of the client 206 of FIG. 2. As shown, the client 206 is equipped with a processor 330, a memory 332, an adapter 340, a reassembler 342, a video decoder 344 and one or more media output devices 346. The video decoder 344 has a base layer decoding component 352 and an enhancement layer decoding component 354, and optionally a bit-plane coding component 356.

Following decoding, the client 206 stores the video in memory 332 and/or plays the video via one or more of the media output devices 346. The client 206 may be embodied in many different ways, including a computer, a handheld entertainment device, a set-top box, a television, an Application Specific Integrated Circuits (ASIC), and so forth.

FIG. 4 conceptually illustrates a layered coding scheme 400 implemented by the video encoder 220 of FIG. 2. To construct a scalable coded bit-stream for transmission over an IP network, the bit-stream must be layered.

In accordance with the principles of the invention, the encoder 220 compression-codes frames of video data into multiple layers, including a base layer (e.g., base layer video 402) and a single enhancement layer (e.g., enhancement layer video 404).

For discussion purposes, FIG. 4 illustrates nine layers: an elementary bit stream (base layer video) 402 which constitutes a high priority partition, an elementary bit stream (enhancement layer video) 404 which constitutes a low priority partition, a base layer movie track 406 (a high priority partition), an enhancement layer movie track 408 (a low priority partition), a hint track 410 for the elementary bit stream (base layer video) 402, and a key feature of the invention, multiple hint tracks 412, 414, 416, 418 for the enhancement layer movie track 408.

To overcome the limitations of the prior art, the present invention introduces the concept of generating multiple hint tracks 412, 414, 416, 418 so as to facilitate the transfer of video data across the network 204, adaptable to changing channel characteristics, complexity constraints and user preferences. When a single movie track, such as the enhancement layer movie track 408, is hinted by multiple hint tracks, such as hint tracks 412, 414, 416, 418, the elementary stream pointed by the enhancement layer movie track 408, will be delivered over the network by multiple RTP connections. In this manner, a flexibility is provided, not available in the prior art, whereby the streaming system is able to adapt video quality to network conditions. That is, only those hint tracks will be used by the server to extract the data from the corresponding elementary bit stream for transmission.

In other words, only those hint tracks will be used, from among the plurality of available hint tracks (e.g., 412, 414, 416, 418), so as to satisfy one or more of the following criteria: prevailing network traffic conditions, complexity constraints, user preferences. For example, as network conditions change, more or less hint tracks may be used from among the plurality of available hint tracks by the server to facilitate the transfer of movie track 408.

Another key feature of the invention is that the plurality of available hint tracks (e.g., 412, 414, 416, 418) contain data information that may be used by any general purpose MPEG-4 streaming server, such as server 205, obviating the need to use dedicated or specialized hardware.

It should also be appreciated that the enhancement layer movie track 408, is only being virtually divided into the multiple hint tracks 412, 414, 416, 418. That is, the elementary layer movie track 408 remains physically unchanged and therefore remains available and intact as originally constructed for local playback.

It should further be appreciated that the multi-track hinting scheme of the invention is not restricted to the layered coding case described above. Rather, the scheme has more general applicability, for example, to a video stream by associating a hint track to each different type of video frame, i.e., I, P and B frames. In this way, temporal video scalability is easily achieved.

It is understood that the systems, functions, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and-executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A method for streaming scalable coded video over a network, the method comprising:
a) encoding a first bit-stream representing a base layer of said scalable coded video;
b) encoding a second bit-stream representing an enhancement layer of said scalable coded video;
c) generating a first hint track to facilitate the transmission of said encoded first bit-stream (base layer) over said network; and
d) generating a plurality of enhancement layer hint tracks to facilitate the transmission of at least a portion of said second bit-stream (enhancement layer) over said network.

2. The method of claim 1, further comprising the steps of:
e) transmitting said encoded first bit-stream (base layer) over said network in accordance with data elements contained within said first hint track;
f) determining said at least a portion of said encoded second bit-stream (enhancement layer) to be transmitted over said network; and
g) transmitting said determined portion of said encoded second bit-stream (enhancement layer) over said network in accordance with data elements contained within one or more enhancement layer hint tracks from among said plurality of enhancement layer hint tracks.

3. The method of claim 2, wherein said step (f) of determining a portion of said encoded second bit-stream to be transmitted is made in accordance with at least one of a prevailing network condition, a network bandwidth variation, a network complexity constraint and a user preference.

4. The method of claim 2, wherein said step (g) of transmitting said determined portion of said encoded second bit-stream further comprises the steps of:
1) identifying those enhancement layer hint tracks from among said plurality of enhancement layer hint tracks required to satisfy said determined portion to be transmitted; and
2) establishing a separate end-to-end network connection for each of said identified enhancement layer hint tracks.

5. The method of claim 4, wherein said established end-to-end network connection is an RTP connection.

6. The method of claim 1, wherein said step (d) of d) generating a plurality of enhancement layer hint tracks to facilitate the transmission of at least a portion of said second bit-stream (enhancement layer) over said network further comprises maintaining said enhancement layer for local playback.

7. A system for streaming scalable coded video over a network, the system comprising:
means for encoding a first bit-stream representing a base layer of said scalable coded video;
means for encoding a second bit-stream representing an enhancement layer of said scalable coded video;
means for generating a first hint track to facilitate the transmission of said encoded first bit-stream (base layer) over said network; and
means for generating a plurality of enhancement layer hint tracks to facilitate the transmission of at least a portion of said second bit-stream (enhancement layer) over said network.

8. The system of claim 1, further comprising:
means for transmitting said encoded first bit-stream (base layer) over said network in accordance with data elements contained within said first hint track;
means for determining said at least a portion of said encoded second bit-stream to be transmitted over said network; and
means for transmitting said at least a portion of said encoded second bit-stream (enhancement layer) over said network in accordance with data elements contained within one or more enhancement layer hint tracks from among said plurality of enhancement layer hint tracks.

9. The system of claim 8, wherein said means for determining said at least a portion of said encoded second bit-stream to be transmitted is made in accordance with at least one of a prevailing network condition, a network bandwidth variation, a network complexity constraint and a user preference.

10. The system of claim 8, wherein said means for transmitting said determined portion of said encoded second bit-stream further comprises:
means for identifying those enhancement layer hint tracks from among said plurality of enhancement layer hint tracks required to satisfy said at least a portion of said encoded second bit-stream to be transmitted; and
means for establishing a separate end-to-end network connection for each of said identified enhancement layer hint tracks from among said plurality of enhancement layer hint tracks.

11. The system of claim 10, wherein said established end-to-end network connections are RTP connections.

12. The system of claim 7, further comprising means for maintaining said enhancement layer to be utilized for local playback.

13. The system of claim 7, wherein said encoder is an MPEG-4 encoder.
